(19) United States
(12) Patent Application Publication
(10) Pub. No.: US 2008/0062936 A1
(43) Pub. Date: Mar. 13, 2008

(54) METHOD AND SYSTEM FOR PROCESSING GROUP RESOURCE ALLOCATIONS

(75) Inventors: Xiao Mei He, Beijing (CN); Hao Bi, Lake Zurich, IL (US); Sean M. McBeath, Keller, TX (US); James O'Connor, Dallas, TX (US); John D. Reed, Arlington, TX (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/530,152

(22) Filed: Sep. 8, 2006

(51) Int. Cl. H04Q 7/24

(52) U.S. Cl. 370/338

(57) ABSTRACT

A method and system for processing, in a wireless communication device, data concerning a group resource allocation enables efficient use of radio frequency resources. The method includes processing a group properties message received from a radio access network (block 1410). The group properties message comprises group properties for a scheduling group, and the group properties comprise a group identifier that identifies the scheduling group. A group assignment message received from the radio access network is then processed (block 1425). The group assignment message comprises the group identifier and a position assignment within the scheduling group. The group properties are then associated with the group assignment message (block 1430).

### FIELD OF THE INVENTION

The present invention relates generally to radio frequency resource allocations in wireless communications networks, and more particularly to efficient signaling methods to support group radio frequency resource allocation schemes.

### BACKGROUND

Providing efficient support for voice transmissions is a fundamental requirement for future wireless communications standards. Many wireless communications systems, such as packet based communications systems, provide voice telephony using the Voice-over-Internet-Protocol (VoIP). Packet based wireless communications systems can support VoIP using various scheduling schemes and other methods to provide a required Quality of Service (QoS). However, associated control channel overhead in such systems can significantly reduce system efficiency.

Because voice data sessions generally utilize smaller packet sizes than non-voice data sessions, a greatly increased number of voice users can often be served over VoIP communications channels, thereby placing a burden on control mechanisms and resources of a VoIP wireless communications system. It is known to use group resource allocation schemes to reduce such a control burden. In group resource allocation schemes, users are placed into scheduling groups, and each scheduling group is assigned a set of shared time-frequency radio resources. The resources then can be allocated to the scheduling group using, for example, bitmap signaling.

While group resource allocation schemes are particularly advantageous for VoIP communication traffic, they are also beneficial for video telephony traffic, gaming traffic, and traditional packet data traffic. Group resource allocation schemes can provide an excellent mechanism for sharing a set of time-frequency resources among a group of users. However, many current group resource allocation schemes are deficient in three ways. First, they do not address how to efficiently assign a user to a group. Second, they do not address how to efficiently change a user from one group to another group. Third, they do not address how to efficiently change the properties of a group. Thus, in general, many current group resource allocation schemes do not address the signaling necessary to efficiently support group resource allocations.

### BRIEF DESCRIPTION OF THE DRAWINGS

In order that the invention may be readily understood and put into practical effect, reference will now be made to exemplary embodiments as illustrated with reference to the accompanying figures, wherein like reference numbers refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 is a schematic diagram illustrating a wireless communications network, as known according to the prior art.

FIG. 2 is a diagram illustrating a sequence of long frames that can be useful for wirelessly transmitting data between an access terminal and a base station in a wireless communications network, as known according to the prior art.

FIG. 3 is a diagram illustrating an exemplary set of time-frequency resources shared between a base station and a plurality of access terminals assigned to a scheduling group in a wireless communications network, as known according to the prior art.

FIG. 4 is a message sequence chart illustrating communications between components of a wireless communications network, according to some embodiments of the present invention.

FIG. 5 is a block diagram illustrating components of a Group Properties message, according to some embodiments of the present invention.

FIG. 6 is a general flow diagram illustrating a method for processing, in a wireless communication device such as an access terminal, a Group Properties message, according to some embodiments of the present invention.

FIG. 7 is a block diagram illustrating components of a Group Properties Complete message, according to some embodiments of the present invention.

FIG. 8 is a block diagram illustrating components of a Group Assignment message, according to some embodiments of the present invention.

FIG. 9 is a general flow diagram illustrating a method for processing, in a wireless communication device such as an access terminal, a Group Assignment message, according to some embodiments of the present invention.

FIG. 10 is a block diagram illustrating components of a Group Assignment Complete message, according to some embodiments of the present invention.

FIG. 11 is a block diagram illustrating components of a Group Properties Request message, according to some embodiments of the present invention.

FIG. 12 is a block diagram illustrating components of a Group Change Request message, according to some embodiments of the present invention.

FIG. 13 is a block diagram illustrating components of a Group Change message, according to some embodiments of the present invention.

FIG. 14 is a general flow diagram illustrating a method for processing, in a wireless communication device, data concerning a group radio frequency resource allocation, according to some embodiments of the present invention.

FIG. 15 is a general flow diagram illustrating a method for processing, in a wireless communication device, data concerning a group radio frequency resource allocation, according to some further embodiments of the present invention.

FIG. 16 is a block diagram illustrating components of an access terminal in a wireless communications network, according to some embodiments of the present invention.

FIG. 17 is a general flow diagram illustrating a method for processing, in a radio access network, data concerning a group resource allocation, according to some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### SUMMARY OF THE INVENTION

According to one aspect, the present invention is a method for processing, in a wireless communication device, data concerning a group resource allocation. The method includes processing a group properties message received from a radio access network. The group properties message comprises group properties for a scheduling group, and the group properties comprise a group identifier that identifies the scheduling group. A group assignment message received from the radio access network is then processed. The group assignment message comprises the group identifier and a position assignment within the scheduling group. The group properties are then associated with the group assignment message.

Advantages of some embodiments of the present invention therefore include enabling efficient processing of control data, in the form of scheduling group control channel messages, concerning group radio frequency resource allocations. Control channel overhead can be reduced as group properties for multiple scheduling groups can be stored at an access terminal. Individual access terminals in a wireless communications network therefore can be efficiently assigned to a particular scheduling group. Such assignments may be based on various considerations such as improving overall network efficiency or improving a quality of service (QoS) for a particular access terminal. Access terminals further can be efficiently reassigned from one scheduling group to another, and the group properties of a group can be efficiently updated when, for example, network circumstances change.

### DETAILED DESCRIPTION

Before describing in detail embodiments that are in accordance with the present invention, it should be observed that the embodiments reside primarily in combinations of method steps and apparatus components related to a method and system for processing group resource allocations. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

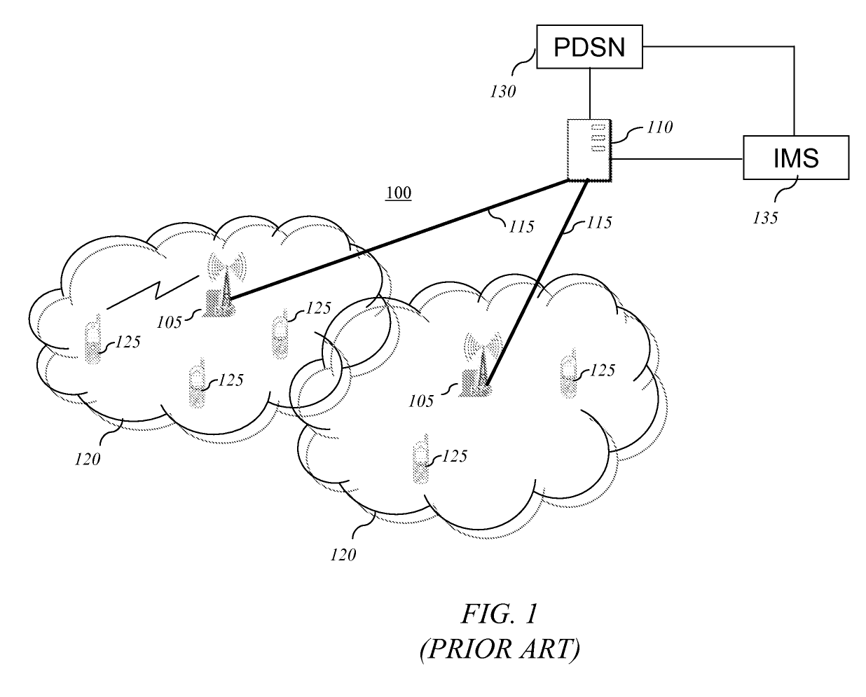

Referring to FIG. 1, a schematic diagram illustrates a wireless communications network 100, as known according to the prior art. A plurality of base stations 105 are connected to a base station controller (BSC) 110 via backhaul connections 115. Each base station 105 has a corresponding base station coverage area 120. Base station coverage areas 120 may overlap and, in general, form an overall network coverage area. Each base station coverage area 120 generally includes a number of access terminals (ATs) 125, such as mobile telephones, notebook computers, or other wireless communication devices that are in wireless communication with a base station 105. The base stations 105 also may be referred to by other names such as base transceiver stations (BTSs), “Node Bs”, Access Points (APs) and access nodes (ANs), depending on the technology involved.

The BSC 110 and the base stations 105 form a Radio Access Network (RAN). The RAN may comprise any number of BSCs 110, each controlling a number of base stations 105. The BSC 110 may alternatively be implemented as a distributed function among the base stations 105. Regardless of specific implementations, the BSC 110 comprises various modules for packetized communications, such as a packet scheduler module, packet segmentation and reassembly module, etc., and modules for assigning appropriate radio resources to the various ATs 125.

The base stations 105 can communicate with the ATs 125 via various standard air interfaces and using various modulation and coding schemes. For example, Universal Mobile Telecommunications System (UMTS), Evolved UMTS (E-UMTS) Terrestrial Radio Access (E-UTRA) or CDMA2000 schemes can be employed. Further, E-UMTS may employ Orthogonal Frequency Division Multiplexing (OFDM) and CDMA2000 may employ orthogonal spreading codes such as Walsh codes. Semi-orthogonal spreading codes also may be utilized to achieve additional channelization over the air interface. Further the network 100 can be an Evolved High Rate Packet Data (E-HRPD) network. Thus various appropriate radio interfaces may be employed in the network 100.

The BSC 110 is also operatively connected to a packet data serving node (PDSN) 130 that connects the BSC 110 to other internet protocol (IP) networks. Further, the BSC 110 is operatively connected to an IP multimedia subsystem (IMS) core 135 for supporting a range of IP-based services over both packet switched (PS) and circuit switched (CS) networks.

The BSC 110, the base stations 105, or some other network infrastructure component, can assign the ATs 125 to one or more scheduling groups for data transmission scheduling purposes. The ATs 125 may be grouped based on various factors such as radio channel quality or other conditions associated with the ATs 125. For example, such conditions can include channel quality information reported by the ATs 125, Doppler statistics reported by the ATs 125, and distance from a base station 105. Alternatively, or additionally, the ATs 125 may be grouped based on one or more access terminal operating characteristics other than participation in a common communication session. Exemplary mobile station operating characteristics include power headroom of an AT 125, macro diversity considerations, capability of an AT 125, service of an AT 125, and codec rate. Further, ATs 125 having an active VoIP session may be grouped together.

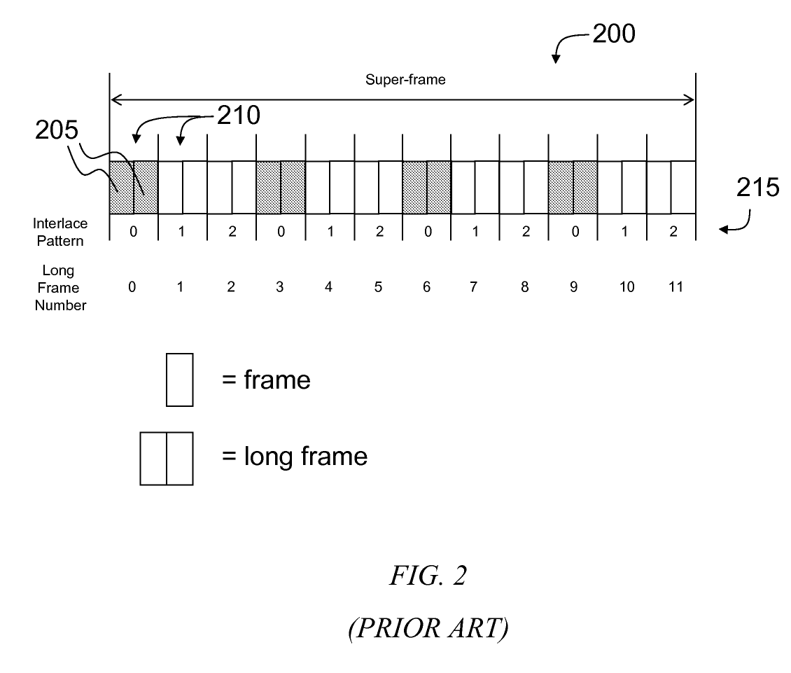

Referring to FIG. 2, a diagram illustrates a sequence 200 of long frames 210 that can be useful for wirelessly transmitting data between an AT 125 and a base station 105 in the wireless communications network 100, as known according to the prior art. Two single frames 205 are grouped to form a long frame 210. In some cases, a long frame 210 also can be equivalent to a single frame 205. As shown in the row 215, an interlace pattern is a sequence of regularly spaced long frames 210. For example, three interlace patterns are contained in the repeating pattern 0,1,2,0,1,2 . . . of the sequence 200. In the sequence 200, 12 long frames 210, denoted long frame 0 through 11, make up a superframe. Where the wireless communications network 100 employs synchronous hybrid automatic repeat request (S-HARQ) algorithms, initial and subsequent transmissions typically occur in one interlace pattern. For example, if an AT 125 is assigned to interlace pattern 0, its S-HARQ transmission will occur in long frames 0, 3, 6, and 9. A preamble may be included in each superframe to carry pilots and other overhead channels. Thus superframes often can improve transmission efficiency of voice data packets, which are generally much smaller than non-voice data packets because voice data are highly compressible and because voice data updates must be sent frequently due to human sensitivity to latency.

Where the wireless communications network 100 employs orthogonal frequency division multiple access (OFDMA) technology, the frequency domain is divided into subcarriers. For example, a 5 MHz OFDMA carrier may be divided into 480 subcarriers, with a subcarrier spacing of 9.6 kHz. An OFDMA frame may be divided into multiple orthogonal frequency division multiplexing (OFDM) symbols. For example, a frame may occupy 0.91144 msec and contain 8 OFDM symbols, where each symbol occupies approximately 113.93 μsec. The subcarriers are then grouped to form block resource channels (BRCHs) and distributed resource channels (DRCHs). A BRCH is a group of contiguous subcarriers that may hop within a larger bandwidth, while a DRCH is a group of noncontiguous sub-carriers.

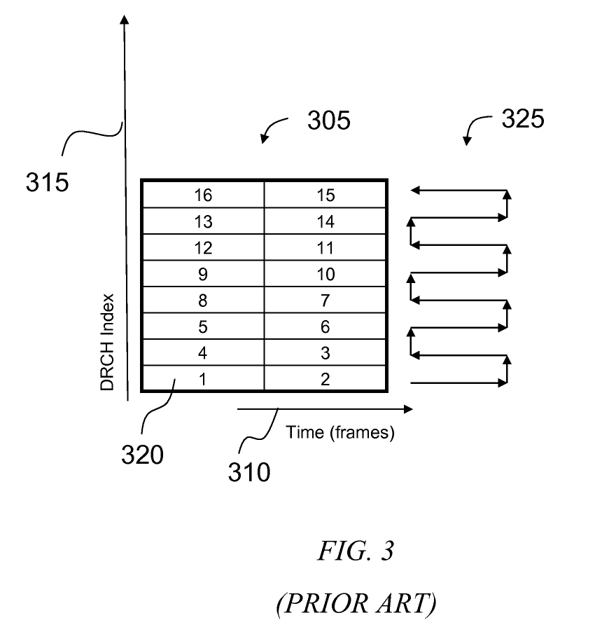

Referring to FIG. 3, a diagram illustrates an exemplary set of shared time-frequency resources 305 shared between a base station 105 and a plurality of ATs 125 assigned to a scheduling group in the wireless communications network 100, as known according to the prior art. The shared time-frequency resources 305 comprise two frames (i.e., one long frame 210 as illustrated in FIG. 2) along a time axis 310, and eight DRCHs along a DRCH index axis 315. A block 320 is defined as one frame in the time domain and one DRCH in the frequency domain, thus the shared time-frequency resources 305 comprise 16 blocks 320, numbered 1 through 16. As previously discussed, a DRCH is a group of non-contiguous subcarriers, so the DRCH index axis 315, is a logical representation of the frequency domain. Each AT 125 in a scheduling group can determine its portion of the shared time-frequency resources 305 of the scheduling group based on resource assignments for other ATs 125 in the scheduling group. Therefore, it is necessary to define the order in which the resources are to be allocated. For example, an ordering pattern 325 is shown which results in the blocks 320 being numbered 1 through 16. The set of shared time-frequency resources 305 then can be repeatedly used in an interlace pattern. For example, the 16 blocks 320 can be repeatedly used in each long frame 210 of position 0 in the interlace pattern shown in FIG. 2. Because the 16 blocks 320 are logical representations of a set of sub-carriers in the frequency domain in a frame, it will be understood by those skilled in the art that the exact physical location of the sub-carriers may change from OFDM symbol to OFDM symbol or from frame to frame.

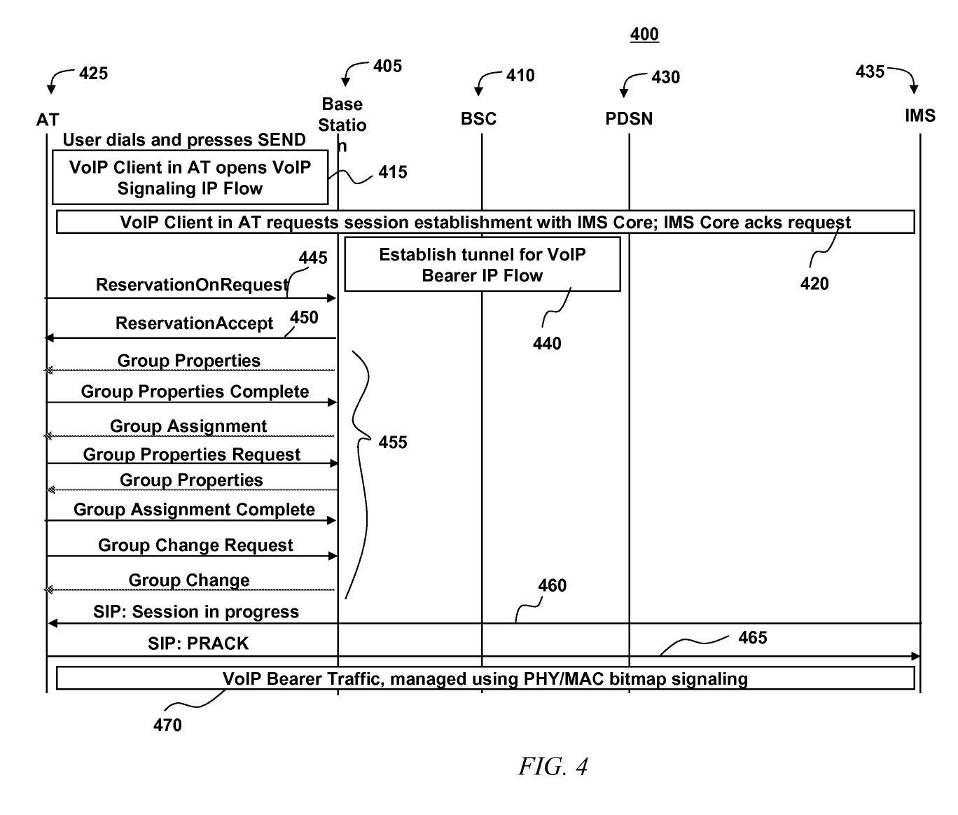

Referring to FIG. 4, a message sequence chart illustrates communications between components of a wireless communications network 400, according to some embodiments of the present invention. The components in the wireless communications network 400 include a base station 405, a base station controller 410, an access terminal (AT) 425, a packet data serving node (PDSN) 430 and an IP multimedia subsystem (IMS) core 435. These components may correspond, for example, to the components in the wireless communications network 100 shown in FIG. 1. When the AT 425, such as a mobile telephone, initiates a VoIP call, a user of the AT 425 typically dials a telephone number and presses a send button on the AT 425. At block 415, a VoIP client in the AT 425 then opens a VoIP signaling IP flow with the base station 405. At block 420, the VoIP client in the AT 425 requests a session establishment with the IMS core 435, and the IMS core 435 acknowledges the request. At block 440, a tunnel for VoIP bearer IP flow is established between the base station 405 and the PDSN 430. At arrow 445, a ReservationOnRequest message is transmitted from the AT 425 to the base station 405, requesting that a Quality of Service (QoS) for a real-time transport protocol (RTP) flow be turned on. At arrow 450, a ReservationAccept message is transmitted from the base station 405 to the AT 425 indicating that a QoS for RTP flow has been changed to an “on” state.

At arrows 455, a series of scheduling group control channel messages are sent and received between the AT 425 and the base station 405. According to some embodiments of the present invention, the scheduling group control channel messages enable the AT 425 to be grouped with other ATs to efficiently allocate limited radio frequency resources in the wireless communications network 400. As described in detail below, the scheduling group control channel messages may enable: 1) the AT 425 to be efficiently assigned to a scheduling group; 2) the AT 425 to be efficiently changed from one scheduling group to another; and 3) the properties of the scheduling group to which the AT 425 is assigned to be efficiently changed. As will be understood by those skilled in the art, the order of the scheduling group control channel messages associated with the arrows 455 can change according to various circumstances and embodiments of the present invention. Further, some of the scheduling group control channel messages can be deleted or repeated according to various circumstances and embodiments of the present invention.

Following the scheduling group control channel messages, at arrow 460, the IMS core 435 transmits a session initiation protocol (SIP) session in progress message to the AT 425. At arrow 465, the AT 425 then responds by transmitting an SIP provisional response acknowledgment (PRACK) message to the IMS core 435. Finally, at block 470, VoIP bearer traffic is transmitted between the AT 425 and the IMS core 435. The VoIP bearer traffic can be managed using, for example, physical layer and medium access control (PHY/MAC) bitmap signaling.

The scheduling group control channel messages associated with the arrows 455 are each described in detail below.

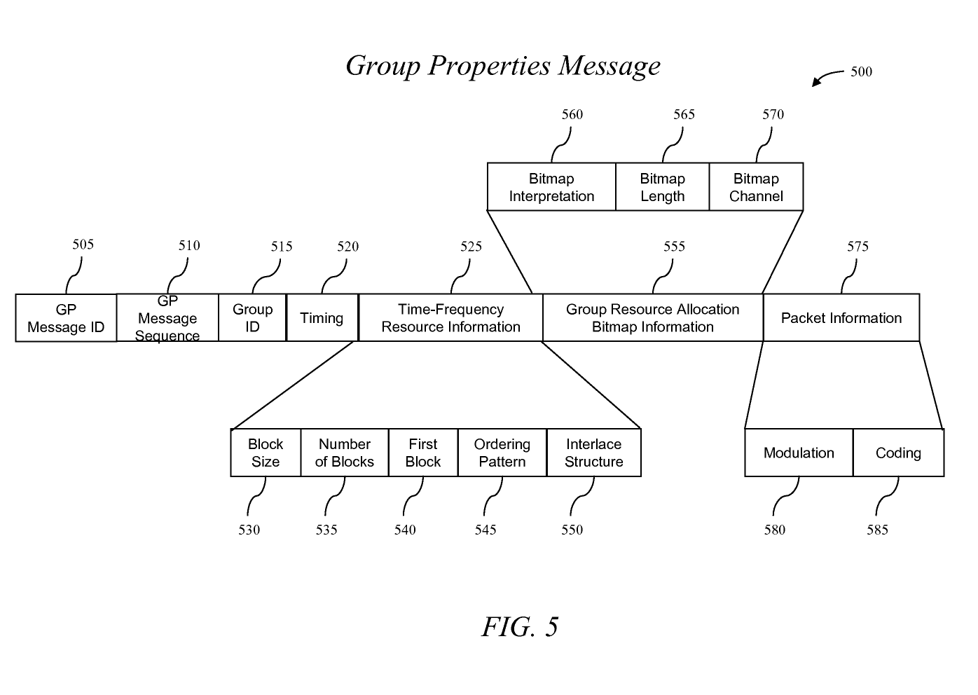

Referring to FIG. 5, a block diagram illustrates components of a Group Properties message 500, according to some embodiments of the present invention. The base station 405 can establish a scheduling group of ATs, including for example the AT 425, for data transmission scheduling purposes. The base station 405 generally indicates to each member of the scheduling group several properties of the scheduling group and at least one property unique to each AT in the scheduling group. The Group Properties message 500 is used by the base station 405 to indicate group properties to ATs, including the AT 425. The Group Properties message 500 comprises a GP (Group Properties) message ID field 505, which is an identifier used by the base station 405 to indicate that the following message fields comprise a Group Properties message. A GP message sequence field 510 is a counter used by the base station 405 to identify each GP message 500. A Group ID field 515 is a unique identifier of a scheduling group. A Timing field 520 comprises an indication of when the GP message 500 will go into effect. For example, the Timing field 520 can indicate that the Group Properties will go into effect immediately; or the Timing field 520 can indicate a predetermined time at which the Group Properties will go into effect, and thus at which time the AT 425 should begin receiving data using time-frequency resources described in the GP message 500. Alternatively, the Timing field 520 can be a superframe index indicating in which superframe the Group Properties will go into effect. Alternatively, the Timing field 520 can be a count down timer, indicating a number of frames before the Group Properties will go into effect. A Time-Frequency Resource Information field 525 comprises information pertaining to a set of shared time-frequency resources that are assigned to a scheduling group.

The Time-Frequency Resource Information field 525 comprises several fields relating to the shared time-frequency resources assigned to a scheduling group. First, a Block Size field 530 is used to indicate the size of one block. A Number of Blocks field 535 is used to indicate the number of blocks assigned to a scheduling group. Where an OFDMA system is defined by logical blocks, where each block has an index, then a First Block field 540 is used to indicate an index of the first block assigned to a scheduling group. An Ordering Pattern field 545 is used to indicate an order in which resources are allocated. An Interlace Pattern field 550 is used to identify an interlace pattern associated with the scheduling group. For example, the Interlace Pattern field 550 may comprise radio frequency resource information including a starting frame and a frame spacing that identifies an interlace pattern.

A Group Resource Allocation Bitmap Information field 555 is used to convey information about a scheduling group resource allocation bitmap. In particular, a Bitmap Interpretation field 560 is used to show how the bitmap should be interpreted. A Bitmap Length field 565 is used to indicate a length of the bitmap itself A Bitmap Channel field 570 is used to indicate a channel (i.e., a set of blocks) on which the scheduling group resource allocation bitmap will be transmitted.

Finally, a Packet Information field 575 is used to indicate information about packets that will be transmitted to scheduling group members. A Modulation field 580 is used to indicate the modulation applied to the packets, while a Coding field 585 is used to indicate an encoder rate, puncturing pattern, or repetition of the packets. The fields of the GP message 500 as described above are intended to be exemplary in nature. It is understood that not all fields are necessary in all embodiments of the present invention, and that additional fields may be required in some cases. Also, the fields of the GP message 500 can be transmitted for one scheduling group at a time or can be transmitted for multiple scheduling groups at once.

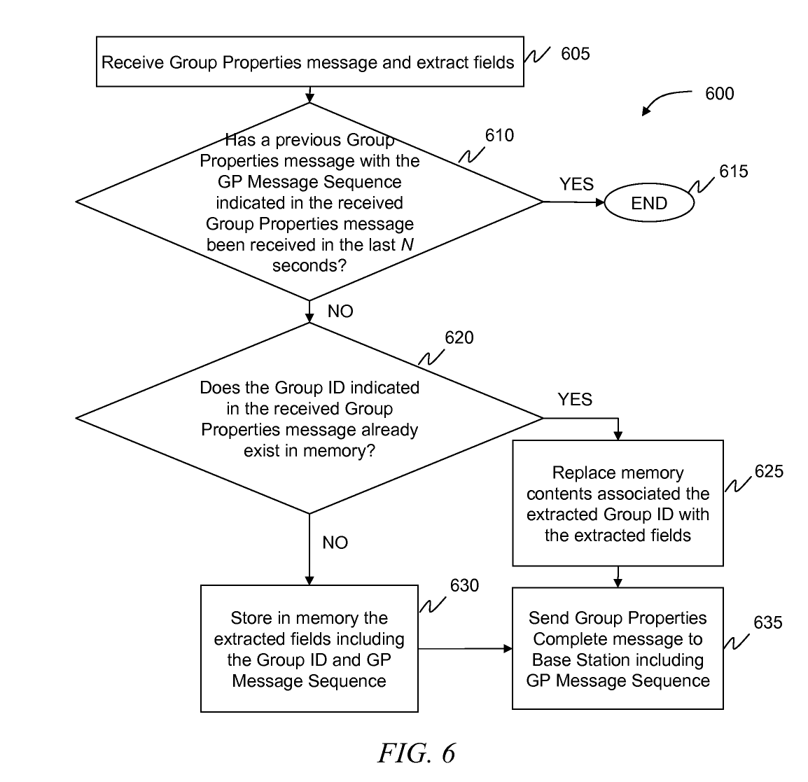

Referring to FIG. 6, a general flow diagram illustrates a method 600 for processing, in a wireless communication device such as the AT 425, a GP message 500, according to some embodiments of the present invention. As shown in FIG. 4, following the ReservationAccept message at arrow 450, consider that the base station 405 transmits the GP message 500 to the AT 425 on a control channel. At block 605 of FIG. 6, the AT 425 receives the GP message 500 and extracts its fields. At block 610, the AT 425 determines if a prior GP message 500 having a GP Message Sequence indicated in the received GP message 500 was already processed within a predetermined time period, such as within the last N seconds, where N can be any number of seconds, including partial seconds. If so, the method 600 ends at block 615. The base station 405 may regularly transmit a GP message 500, for example once every second, so if a prior GP message 500 having a matching GP Message Sequence was received in the last N seconds, then there may not be a need to update some group properties at the AT 425. The value of N can be obtained in various ways such as, for example, being sent from the base station 405 to the AT 425 in a separate message or being permanently stored at the AT 425. If however a prior GP message 500 was not received in the last N seconds, the method 600 continues at block 620, where the AT 425 determines whether a Group ID indicated in the received GP message 500 already exists in a memory of the AT 425. If so, at step 625 the AT 425 replaces memory contents associated with an extracted Group ID field 515 with the remaining extracted fields, including the GP Message Sequence field 510. If not, then at block 630 the AT 425 stores in a memory the extracted fields including the Group ID field 515 and the GP Message Sequence field 510. Finally, after block 625 or block 630, at block 635, the AT 425 sends a Group Properties Complete (GPC) message 700 to the base station 405, including the GP Message Sequence field 510.

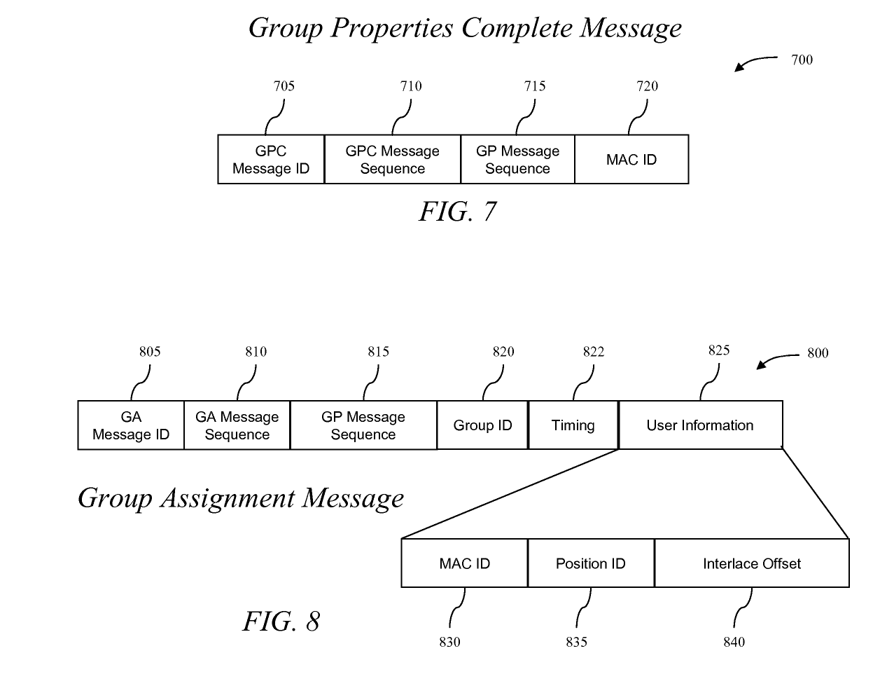

Referring to FIG. 7, a block diagram illustrates components of a GPC message 700, according to some embodiments of the present invention. A GPC message 700 comprises a GPC Message ID field 705, a GPC Message Sequence field 710, A GP Message Sequence field 715, and a Medium Access Control identification (MAC ID) associated with the AT 425. The MAC ID is a unique identifier of the AT 425 and can be, for example, an Electronic Serial Number (ESN), a subscriber hardware identifier, a Medium Access Control Index (MAC Index), or any other suitable identifier that uniquely identifies the AT 425.

When the base station 405 transmits a GP message 500, several ATs may then need to transmit a GPC message 700. It is generally not desirable for all ATs in a scheduling group to transmit a GPC message 700 at the same time. Therefore, according to some embodiments of the present invention, only ATs currently assigned to the scheduling group associated with the received GP message 500 will transmit a GPC message 700. Further, the ATs may wait an amount of time proportional to its assigned group position, which group position is described in detail below, before transmitting a GPC message 700. In this way, the various GPC messages 700 are distributed in the time domain. Also, according to some embodiments of the present invention, a GPC message 700 is transmitted to a radio access network, such as to the base station 405, only if the GPC message 700 contains an update to a current scheduling group.

Referring to FIG. 8, a block diagram illustrates components of a Group Assignment (GA) message 800, according to some embodiments of the present invention. After a GP message 500 is transmitted, the base station 405 can assign ATs, such as the AT 425, to a scheduling group. A GA message 800 is used by the base station 405 to indicate that a particular AT 425 is assigned to a particular scheduling group. A GA message 800 comprises a GA Message ID field 805, which is an identifier used by the base station 405 to indicate that the following message fields comprise a GA message 800. A GA Message Sequence field 810 is a counter used by the base station 405 to identify each GA message 800. A GP (Group Properties) Message Sequence field 815 is a counter that corresponds to a most recent GP Message Sequence field 510 of a GP message 500 having a Group ID field 515 corresponding to a Group ID field 820, which is a unique identifier of a scheduling group. A Timing field 822 comprises an indication of when the GA message 800 will go into effect. For example, the Timing field 822 can indicate that the Group Assignment will go into effect immediately. Or the Timing field 822 can indicate that the AT 425 should begin receiving data at a predetermined time using time-frequency resources described in a GP message 500. Alternatively, the Timing field 822 can be a superframe index indicating in which superframe a Group Assignment will go into effect. A User Information field 825 is used to indicate information about the AT 425. The User Information field 825 comprises a MAC ID field 830.

According to some embodiments of the present invention, the MAC ID field 830 is not transmitted as part of a payload of a GA message 800, but is rather used by the base station 405 to scramble and thus encode a GA message 800. In that way, each AT receiving a GA message 800 descrambles the message with its own MAC ID, but only a targeted AT, such as the AT 425, will be able to decode the GA message 800.

A Position ID field 835 can be used to indicate to the AT 425 its assigned group position within a scheduling group, such as a bitmap position. An Interlace Offset field 840 is used to indicate to the AT 425 in which long frame of an interlace pattern its first HARQ transmission will occur. The fields of a GA message 800 as described above are intended to be exemplary in nature. It is understood that not all fields are necessary in all cases, and that additional fields may be required in some cases. According to some embodiments of the present invention, the fields of a GP message 500 are also included in a GA message 800. In other embodiments of the present invention, the fields of a GP message 500 for multiple groups are also included in a GA message 800, and an AT can be assigned to multiple interlace offsets. This allows an access network to begin a new packet transmission for a particular AT in multiple interlace offsets, where there are multiple occurrences of the Position ID field 835 and the Interlace Offset field 840.

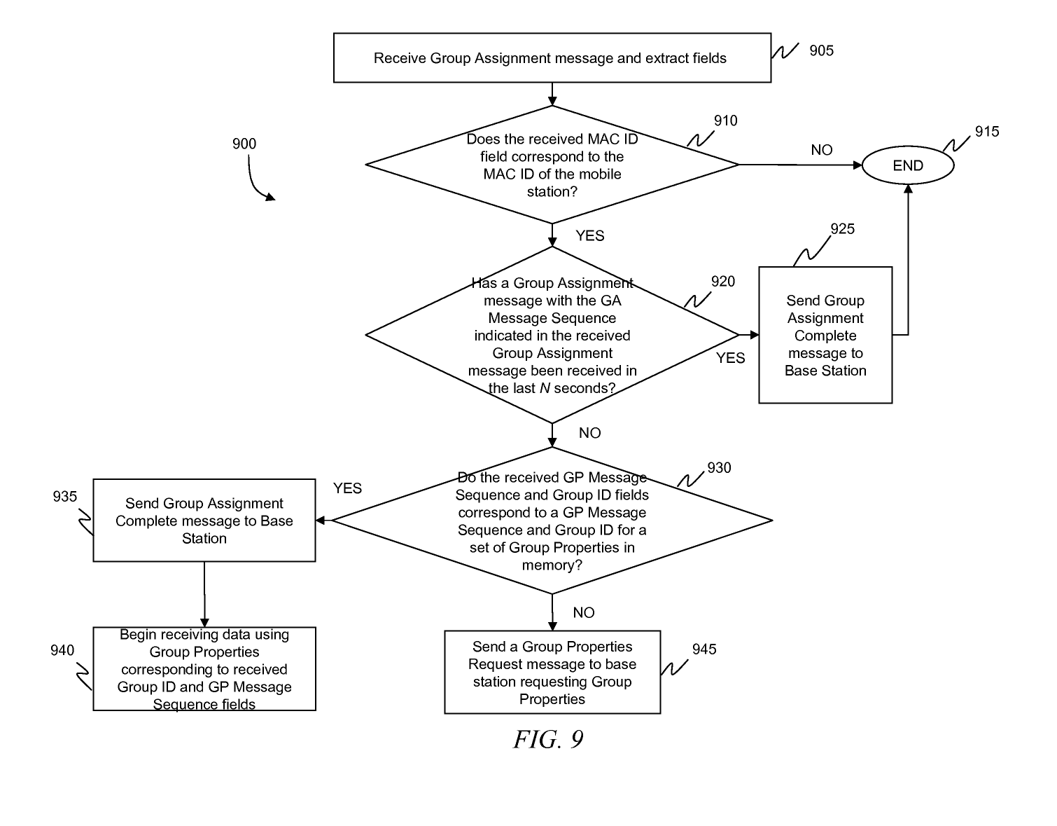

Referring to FIG. 9, a general flow diagram illustrates a method 900 for processing, in a wireless communication device such as the AT 425, a GA message 800, according to some embodiments of the present invention. As shown in FIG. 4, following receipt of a GPC message 700, consider that the base station 405 transmits a GA message 800 to the AT 425 on a control channel. At block 905 of FIG. 9, the AT 425 receives the GA message 800 and extracts its fields. At block 910, it is determined whether a received MAC ID field 830 corresponds to a MAC ID of the AT 425. If not, at block 915 the method 900 ends. If so, at block 920, it is determined whether a GA message 800 having a GA Message Sequence indicated in a received GA Message Sequence field 810 has been received in the last N seconds. If so, then at block 925 a Group Assignment Complete (GAC) message 1000 is transmitted to the base station 405. The method 900 then ends at block 915.

If at block 920 it is determined that a GA message 800 having a GA Message Sequence indicated in a received GA Message Sequence field 810 has not been received in the last N seconds, then at block 930 it is determined whether a received GP Message Sequence field 815 and Group ID field 820 correspond to a GP Message Sequence and Group ID for a set of Group Properties in a memory of the AT 425. If so, then at block 935 a GAC message 1000 is transmitted to the base station 405. At block 940, the AT 425 begins receiving VoIP data using the Group Properties corresponding to the received Group ID field 820 and GP Message Sequence field 815 according to the Timing Field 822. However, if at block 930 it is determined that a received GP Message Sequence field 815 and Group ID field 820 do not correspond to a GP Message Sequence and Group ID for a set of Group Properties in a memory of the AT 425, then at block 945 the AT 425 transmits a Group Properties Request message 1100 to the base station 405.

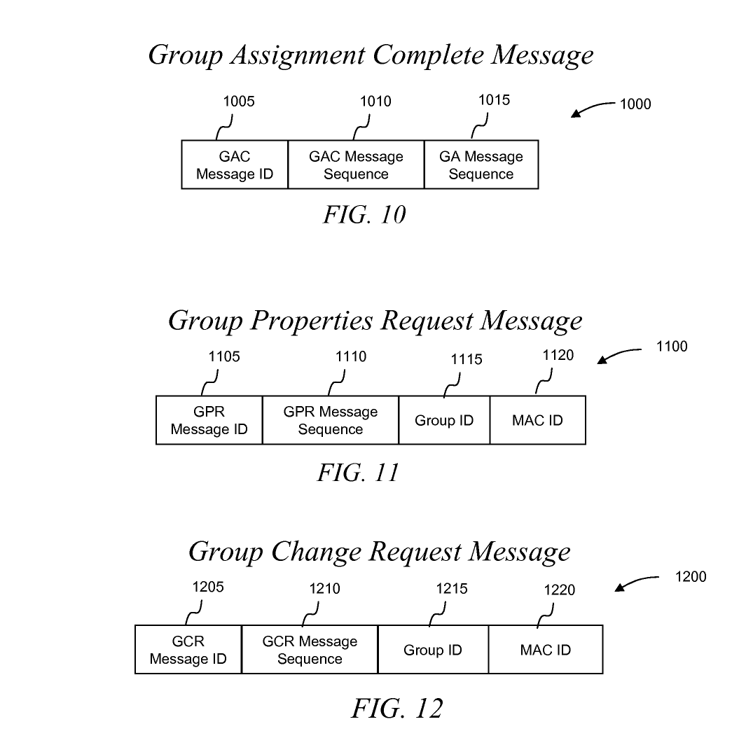

Referring to FIG. 10, a block diagram illustrates components of a Group Assignment Complete (GAC) message 1000, according to some embodiments of the present invention. The GAC message 1000 comprises a GAC Message ID field 1005, a GAC Message Sequence field 1010, and a GA Message Sequence field 1015.

Referring to FIG. 11, a block diagram illustrates components of a Group Properties Request (GPR) message 1100, according to some embodiments of the present invention. The GPR message 1100 comprises a GPR Message ID field 1105, a GPR Message Sequence field 1110, a Group ID field 1115, and a MAC ID field 1120 that includes the MAC ID of an AT such as the AT 425.

According to some embodiments of the present invention, an AT such as the AT 425 also can request that its group assignment be changed from one group to another group. An AT may request that its group assignment be changed for various reasons including, for example, changes in radio channel conditions and movement of the AT relative to a base station. For example, a group change can be initiated by the AT 425 transmitting a Group Change Request (GCR) message 1200 to the base station 405. The base station 405 then transmits a Group Change (GC) message 1300 back to the AT 425.

Referring to FIG. 12, a block diagram illustrates components of a Group Change Request (GCR) message 1200, according to some embodiments of the present invention. The GCR message 1200 comprises a GCR message ID field 1205, a GCR Message Sequence field 1210, a Group ID field 1215, and a MAC ID field 1220 that includes the MAC ID of an AT such as the AT 425.

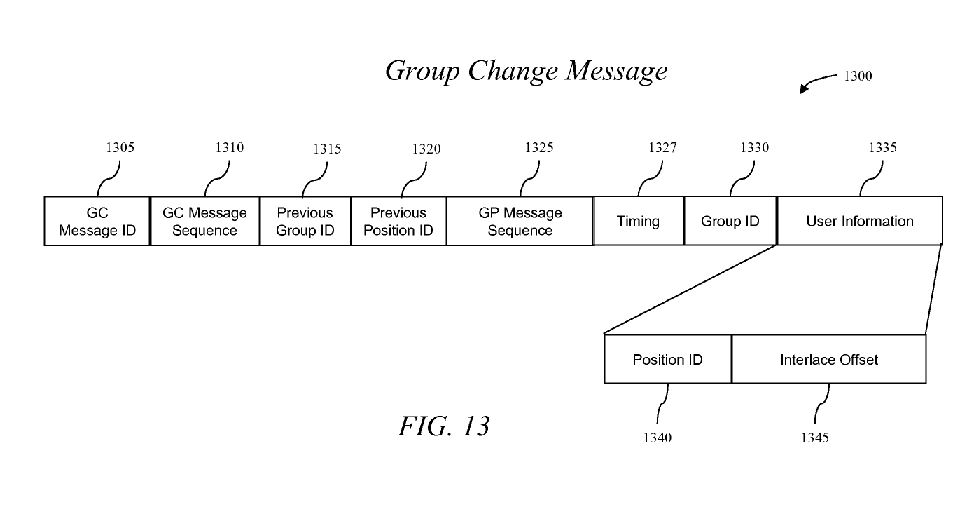

Referring to FIG. 13, a block diagram illustrates components of a Group Change (GC) message 1300, according to some embodiments of the present invention. The GC message 1300 comprises a GC message ID field 1305, a GC Message Sequence field 1310, a Previous Group ID field 1315, and a Previous Position ID field 1320. A GC message 1300 then also may include group data that are similar to the group data included in a GA Message 800. For example, a GC Message 1300 may include a GP Message Sequence field 1325, a Group ID field 1330, a Timing field 1327, and a User Information field 1335 including a Position ID 1340 and an Interlace Offset field 1345. The Timing field 1327 comprises an indication of when the GC message 800 will go into effect. In some embodiments of the present invention, the Previous Group ID field 1315 and the Previous Position ID field 1320 are replaced by a MAC ID field. In other embodiments of the present invention, a MAC ID field is included in addition to the Previous Group ID field 1315 and the Previous Position ID field 1320. Note that the base station 405 may transmit a GC message 1300 to the AT 425 even if the base station 405 has not received a GCR message 1200.

### EXAMPLES

Below are illustrative examples of the operation of the scheduling group control channel messages described above, according to some embodiments of the present invention. For purposes of brevity and clarity, some of the fields described above of the scheduling group control channel messages are deleted from and are not described in the present examples.

Consider that at time 0, the AT 425, having MAC ID ‘111100001111’, does not have any Group Properties stored in its memory. Further, at time 0, the base station 405 transmits a first GP message 500 having the following binary field values:
GP Message ID=‘001’;
GP Message Sequence=‘001’;
Group ID=‘001’;
Number of Blocks=‘100’;
First Block=‘001’.

At time 0, the AT 425 successfully receives and processes the first GP message 500, so it stores the second through fourth values above in memory and transmits a Group Properties Complete (GPC) message 700 to the base station 405 with the following binary field values:
GPC Message ID=‘011’;
GPC Message Sequence=‘001’;
GP Message Sequence=‘001’;
MAC ID=‘111100001111’.

At time 1, the base station 405 transmits a second GP message 500 having the following binary field values:
GP Message ID=‘001’;
GP Message Sequence=‘010’;
Group ID=‘010’;
Number of Blocks=‘111’;
First Block=‘111’.

At time 1, the AT 425 successfully receives and processes the second GP message 500, and determines that properties for Group ID ‘010’ do not already exist in memory, so it stores the second through fourth values above in memory and transmits a GPC message 700 to the base station 405 having the following binary field values:
GPC Message ID=‘011’;
GPC Message Sequence=‘010’;
GP Message Sequence=‘010’;
MAC ID=‘111100001111’.

At time 2, the base station 405 transmits a third GP message 500 having the following binary field values:
GP Message ID=‘001’;
GP Message Sequence=‘011’;
Group ID=‘001’;
Number of Blocks=‘101’;
First Block=‘001’.

At time 2, the AT 425 successfully receives and processes the third GP message 500, and determines that properties for Group ID ‘001’ already exist in memory, as the properties for Group ID ‘001’ were already received with the first GP message 500. The AT 425 therefore replaces the memory contents associated with Group ID ‘001’ with the second through fourth values above and transmits a GPC message 700 to the base station 405 having the following binary field values:
GPC Message ID=‘011’;
GPC Message Sequence=‘011’;
GP Message Sequence=‘011’;
MAC ID=‘111100001111’.

For clarity, the arrows 455 of FIG. 4 show transmission of only one GP message 500 and one GPC message 700. However, as described above, according to some embodiments of the present invention, additional GP messages 500 comprising additional group properties for at least one additional scheduling group can be periodically transmitted by the based station 405 and processed by the AT 425. The at least one additional scheduling group is identified by an additional group identifier, and additional group properties are associated with additional message sequence identifiers. Also, additional GP messages 500 concerning one scheduling group also can be periodically transmitted by the based station 405 and processed by the AT 425.

At time 3, the base station transmits a fourth GP message 500 having the following binary field values:
GP Message ID=‘001’;
GP Message Sequence=‘100’;
Group ID=‘011’;
Number of Blocks=‘010’;
First Block=‘110’.

At time 3, consider that the AT 425 does not receive the fourth GP message 500, so the AT 425 does not respond to the fourth GP message 500.

At time 4, the base station 405 transmits a Group Assignment (GA) message 800 to the AT 425 with MAC ID ‘111100001111’ having the following binary field values:
GA Message ID=‘010’;
GA Message Sequence=‘001’;
GP Message Sequence=‘100’;
Group ID=‘011’;
MAC ID=‘111100001111’;
Position ID=‘001’;
Interlace Offset=‘001’.

At time 4, the AT 425 successfully receives and processes the GA message 800, and determines that properties for Group ID ‘011’ and GP Message Sequence ‘100’ are not already stored in memory, therefore the AT 425 needs to obtain such properties from the base station 405 before the AT 425 can transmit a Group Assignment Complete (GAC) message 1000 to the base station 405. The AT 425 therefore transmits to the base station 405 a Group Properties Request (GPR) message 1100 having the following binary field values:
GPR Message ID=‘111’;
GPR Message Sequence=‘001’;
Group ID=‘011’;
MAC ID=‘111100001111’.

At time 5, in response to the GPR message 1100, the base station 405 retransmits the fourth GP message 500 having the following binary field values:
GP Message ID=‘001’;
GP Message Sequence=‘100’;
Group ID=‘011’;
Number of Blocks=‘010’;
First Block=‘110’.

At time 5, the AT 425 successfully receives and processes the fourth GP message 500. The AT 425 is then able to begin receiving data according to the fourth GP message 500 and the GA message 800. The group properties for a first scheduling group identified by Group ID ‘001’ and the additional group properties for the additional scheduling groups identified by Group ID ‘010’ and Group ID ‘011’ are all stored in a memory of the wireless communication device. The AT 425 therefore transmits a Group Assignment Complete (GAC) message 1000 to the base station 405 having the following binary field values:
GAC Message ID=‘100’;
GAC Message Sequence=‘001’;
GA Message Sequence=‘001’.

At time 6, the AT 425 transmits a Group Change Request (GCR) Message 1200 to the base station 405 having the following binary field values:
GCR Message ID=‘101’;
GCR Message Sequence=‘001’;
Group ID=‘010’;
MAC ID=‘111100001111’.

At time 7, the base station 405 then transmits a Group Change (GC) Message 1300 to the AT 425 having the following binary field values:
GC Message ID=‘110’;
GC Message Sequence=‘001’;
Previous Group ID=‘011’;
Previous Position ID=‘001’;
GP Message Sequence=‘010’;
Group ID=‘010’;
Position ID=‘001’.

The examples above are intended to provide a concise illustration of a use of each of the scheduling group control channel messages described herein. Those skilled in the art will appreciate that the complete sequence of messages provided in the examples may not be applicable to actual working embodiments of the present invention.

It is sometimes necessary for an AT to be handed off from one base station (i.e., an original base station) to another base station (i.e., a new base station). The following is an example of how the messages described above are used to perform such a handoff. First, the AT indicates its desire to be handed off to the new base station, using a message, as is well known in the art. The new base station receives the message and assigns the AT temporary time-frequency resources for receiving data. The new base station then transmits a GP message 500, followed by a GA message 800. Note that the GP message 500 and the GA message 800 can be received from a radio access network in one message, as was previously described. The Timing field 822 of the GA message 800 is set to the index of a future superframe, so the AT knows when to stop using the temporary time-frequency resource and begin using shared time-frequency resources of a scheduling group assigned using the GA message 800. Under normal operation, the AT receives the GA message 800 and transmits a GAC message 1000 to the new base station. If the new base station receives the GAC message 1000, the new base station transmits data to the AT using the shared time-frequency resources of the scheduling group at the superframe corresponding to the Timing field 822 of the GA message 800. If the new base station does not receive the GAC message 1000 before the superframe index indicated in the Timing field 822 of the GA message 800, then the new base station transmits data to the AT on both the temporary time-frequency resources and the shared time-frequency resources of the scheduling group. The new base station then transmits another GA message 800. The process above is then repeated until the new base station receives a GAC message 1000, at which time the new base station discontinues transmitting data to the AT on the temporary time-frequency resources.

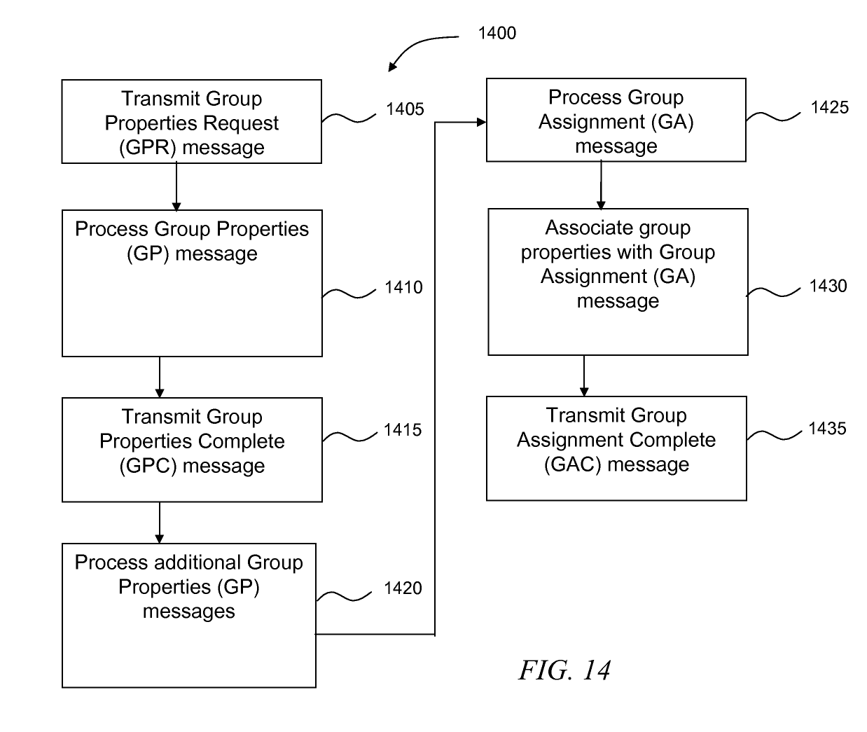

Referring to FIG. 14, a general flow diagram illustrates a method 1400 for processing, in a wireless communication device such as the AT 425, data concerning a group radio frequency resource allocation, according to some embodiments of the present invention. At block 1405, a group properties request message is transmitted to a radio access network. For example, the AT 425 transmits a GPR message 1100 to the base station 405. At block 1410, a group properties message is received from a radio access network and processed. The group properties message comprises group properties for a scheduling group, and the group properties comprising a group identifier that identifies the scheduling group. For example, the AT 425 processes a GP message 500 received from the base station 405, where the GP message 500 comprises a Group ID field 515. At block 1415, a group properties complete message is transmitted to the radio access network. For example, the AT 425 transmits a GPC message 700 to the base station 405. At block 1420, additional group properties messages are processed. For example, the additional group properties messages may comprise additional group properties for additional scheduling groups. The additional scheduling groups may be identified by additional group identifiers, and the additional group properties may be associated with additional message sequence identifiers. For example the AT 425 receives from the base station 405 and processes a plurality of GP messages 500 associated with various scheduling groups. Alternatively, one or more additional group properties messages may be received from the radio access network concerning the same group. In such case the at least one additional group properties message comprises a group identifier and updated group properties for the same scheduling group identified in an earlier group properties message.

At block 1425, a group assignment message received from the radio access network is processed. The group assignment message comprises a group identifier and a position assignment within a scheduling group. For example, the AT 425 receives from the base station 405 and processes a GA message 800. At block 1430, group properties received in one of the group properties messages for a group identified in the group assignment message are associated with the group assignment message. Such association can occur by comparing a group properties message sequence identifier included in the group assignment message with the message sequence identifier included in the group properties message; or by comparing the group identifier included in the group assignment message with the group identifier included in the group properties message. For example, a counter included in a GA message 800, such as the GP Message Sequence field 815, can be compared with the GP Message Sequence field 510 of a GP message 500. If the GP Message Sequence field 815 of a GA message 800 for a particular Group ID matches the GP Message sequence field 510 of a GP message 500, then the AT 425 knows that is has the current set of Group Properties for the scheduling group, such as those contained in the Time-frequency resource information field 525 in a GP message 500, and can begin receiving information on group resources according to the Timing field 822. At block 1435, a group assignment complete message is transmitted to the radio access network. For example, the AT 425 transmits a GAC message 1000 to the base station 405.

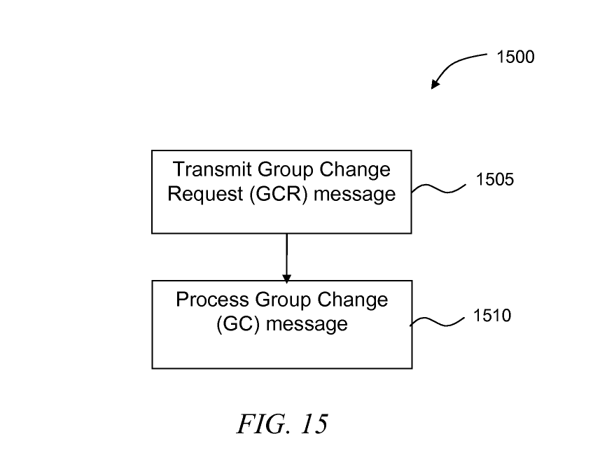

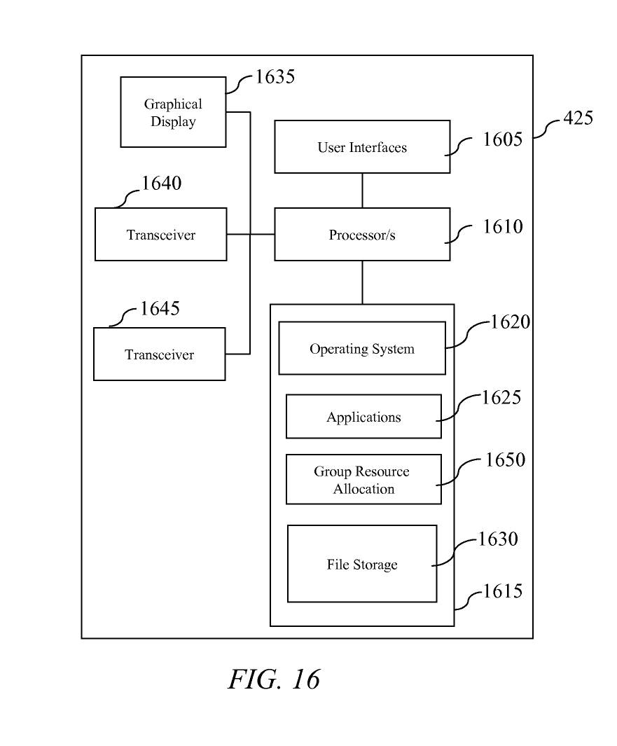

Referring to FIG. 15, a general flow diagram illustrates a method 1500 for processing, in a wireless communication device such as the AT 425, data concerning a group radio frequency resource allocation, according to some embodiments of the present invention. At block 1505 a group change request message is transmitted to a radio access network. For example, the AT 425 transmits to the base station 405 a GCR message 1200. At block 1510, a group change message, received from the radio access network in response to the group change request message, is processed. For example, the AT 425 processes a GC message 1300 received from the base station 405.

Referring to FIG. 16, a block diagram illustrates components of the Access Terminal (AT) 425 in the wireless communications network 400, according to some embodiments of the present invention. The AT 425 can be one of various types of wireless communication devices such as, for example, a mobile telephone, personal digital assistant, or notebook computer. The AT 425 comprises user interfaces 1605 operatively coupled to at least one processor 1610. At least one memory 1615 is also operatively coupled to the processor 1610. The memory 1615 has storage sufficient for an operating system 1620, applications 1625 and general file storage 1630. The general file storage 1630 may store, for example, values associated with group properties that are received in a Group Properties (GP) message 500. The user interfaces 1605 may be a combination of user interfaces including, for example, but not limited to a keypad, touch screen, and voice activated command input. A graphical display 1635, which may also have a dedicated processor and/or memory, drivers etc., is operatively coupled to the processor 1610. A number of transceivers, such as a first transceiver 1640 and a second transceiver 1645, are also operatively coupled to the processor 1610. The first transceiver 1640 and the second transceiver 1645 may be for communicating with various wireless communications networks, such as the wireless communications network 400, using various standards such as, but not limited to, Evolved Universal Mobile Telecommunications Service Terrestrial Radio Access (E-UTRA), Universal Mobile Telecommunications System (UMTS), Enhanced UMTS (E-UMTS), Enhanced High Rate Packet Data (E-HRPD), Code Division Multiple Access 2000 (CDMA2000), Institute of Electrical and Electronics Engineers (IEEE) 802.11, IEEE 802.16, and other standards.

It is to be understood that FIG. 16 is for illustrative purposes only and illustrates some components of the AT 425 in accordance with some embodiments of the present invention, and is not intended to be a complete schematic diagram of the various components and connections there between required for all access terminals that may implement various embodiments of the present invention.

The memory 1615 comprises a computer readable medium that records the operating system 1620, the applications 1625, and the general file storage 1630. The computer readable medium also comprises computer readable program code components 1650 for processing data concerning a group radio frequency resource allocation. When the computer readable program code components 1650 are processed by the processor 1610, they are configured to cause the execution of the method 600, the method 900, the method 1400 or the method 1500 as described above, according to some embodiments of the present invention.

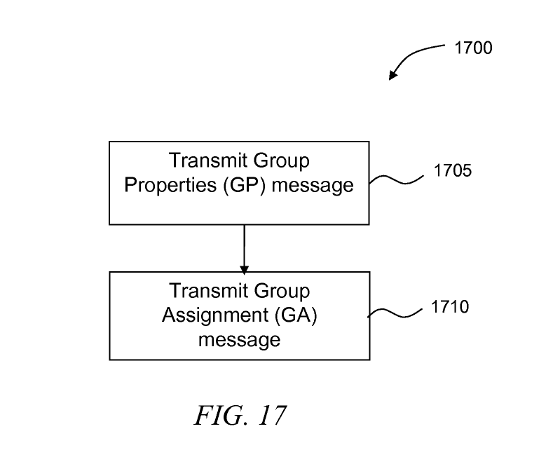

Referring to FIG. 17, a general flow diagram illustrates a method 1700 for processing, in a radio access network, data concerning a group resource allocation, according to some embodiments of the present invention. At block 1705, a group properties message is transmitted to an access terminal. The group properties message comprises group properties for a scheduling group, and the group properties comprise a group identifier that identifies the scheduling group. For example, the base station 405 transmits a GP message 500 to the AT 425, where the GP message 500 comprises a Group ID field 515. At block 1710, a group assignment message is transmitted to the radio access terminal, where the group assignment message comprises the group identifier and a position assignment within the scheduling group. For example, the base station 405 transmits a GA message 800 to the AT 425, where the GA message 800 comprises a Group ID field 820 and a Position ID field 835.

Advantages of some embodiments of the present invention therefore include enabling efficient processing of control data, in the form of scheduling group control channel messages, concerning group radio frequency resource allocations. Control channel overhead can be reduced as group properties for multiple scheduling groups can be stored at an access terminal. Individual access terminals in a wireless communications network therefore can be efficiently assigned to a particular scheduling group. Such assignments may be based on various considerations such as improving overall network efficiency or improving a quality of service (QoS) for a particular access terminal. Access terminals further can be efficiently reassigned from one scheduling group to another, and the group properties of a scheduling group can be efficiently updated when, for example, network circumstances change.

It will be appreciated that embodiments of the invention described herein may be comprised of one or more conventional processors and unique stored program instructions that control the one or more processors to implement, in conjunction with certain non-processor circuits, some, most, or all of the functions of processing group resource allocations as described herein. The non-processor circuits may include, but are not limited to, a radio receiver, a radio transmitter, signal drivers, clock circuits, power source circuits, and user input devices. As such, these functions may be interpreted as steps of a method for processing group resource allocations. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any elements that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims.

We claim:

1. A method for processing, in a wireless communication device, data concerning a group resource allocation, the method comprising:
processing a group properties message received from a radio access network, the group properties message comprising group properties for a scheduling group, and the group properties comprising a group identifier that identifies the scheduling group;
processing a group assignment message received from the radio access network, the group assignment message comprising the group identifier and a position assignment within the scheduling group; and
associating the group properties with the group assignment message.

2. The method of claim 1, wherein the group properties message and the group assignment message are received from the radio access network in one message.

3. The method of claim 1, wherein the group properties message further comprises a message sequence identifier that is associated with the group properties.

4. The method of claim 1, further comprising:
processing additional group properties messages comprising additional group properties for at least one additional scheduling group, the at least one additional scheduling group identified by an additional group identifier.

5. The method of claim 3, wherein the group properties are associated with the group assignment message by comparing:
a group properties message sequence identifier included in the group assignment message with the message sequence identifier included in the group properties message; or
the group identifier included in the group assignment message with the group identifier included in the group properties message.

6. The method of claim 1, further comprising:
transmitting a group properties complete message to the radio access network after processing the group properties message;

7. The method of claim 1, further comprising:
transmitting a group assignment complete message to the radio access network after processing the group assignment message.

8. The method of claim 1, further comprising:
processing an additional group properties message received from the radio access network, the additional group properties message comprising the group identifier and updated group properties for the scheduling group; and
transmitting a group properties complete message to the radio access network.

9. The method of claim 6, wherein the wireless communication device waits an amount of time proportional to an assigned group position before transmitting the group properties complete message.

10. The method of claim 1, further comprising:
transmitting a group properties request message to the radio access network, wherein the group assignment message is processed before the group properties message, and the group identifier in the group assignment message is not recognized by the wireless communication device when the group assignment message is processed.

11. The method of claim 1, further comprising:
transmitting a group change request message to the radio access network; and
processing a group change message, received from the radio access network in response to the group change request message.

12. The method of claim 1, wherein the group properties message and the group assignment message are broadcast to a plurality of wireless communication devices.

13. The method of claim 1, wherein the group properties message further comprises radio frequency resource information including a starting frame and a frame spacing that identifies an interlace pattern.

14. The method of claim 1, wherein the group assignment message is scrambled using a medium access control identification associated with the wireless communication device.

15. The method of claim 1, wherein processing the group properties message comprises determining whether another group properties message comprising the message sequence identifier has already been processed, within a predetermined time period, by the wireless communication device.

16. The method of claim 1, wherein the wireless communication device begins receiving data at a predetermined time using time-frequency resources described in the group properties message, and the predetermined time is determined from the group assignment message.

17. A method for processing, in a radio access network, data concerning a group resource allocation, the method comprising:
transmitting a group properties message to an access terminal, the group properties message comprising group properties for a scheduling group, and the group properties comprising a group identifier that identifies the scheduling group; and
transmitting a group assignment message to the radio access terminal, the group assignment message comprising the group identifier and a position assignment within the scheduling group.

18. A system for processing, in a wireless communication device, data concerning a group radio frequency resource allocation, the system comprising:
computer readable program code components configured to process a group properties message received from a radio access network, the group properties message comprising group properties for a scheduling group, and the group properties comprising a group identifier that identifies the scheduling group;
computer readable program code components configured to cause processing of a group assignment message received from the radio access network, the group assignment message comprising the group identifier and a position assignment within the scheduling group; and
computer readable program code components configured to cause associating the group properties with the group assignment message.

19. The system of claim 18, wherein the group properties message and the group assignment message are received from the radio access network in one message.

20. The system of claim 18, wherein the group properties message further comprises a message sequence identifier that is associated with the group properties.

21. The system of claim 18, further comprising:
computer readable program code components configured to cause processing of additional group properties messages comprising additional group properties for at least one additional scheduling group, the at least one additional scheduling group identified by an additional group identifier.

22. The system of claim 20, wherein the group properties are associated with the group assignment message by comparing:
a group properties message sequence identifier included in the group assignment message with the message sequence identifier included in the group properties message; or
the group identifier included in the group assignment message with the group identifier included in the group properties message.

23. The system of claim 18, further comprising:
computer readable program code components configured to cause transmitting a group properties complete message to the radio access network after processing the group properties message.

24. The system of claim 18, further comprising:
computer readable program code components configured to cause transmitting a group assignment complete message to the radio access network after processing the group assignment message.

25. The system of claim 18, further comprising:
computer readable program code components configured to cause transmitting a group properties complete message to the radio access network only if the group properties message contains an update to a current scheduling group.
